(19) United States
(12) Patent Application Publication
(10) Pub. No.: US 2018/0272164 A1
(43) Pub. Date: Sep. 27, 2018

(54) Portable remote fire suppression systems

(71) Applicant: Stephen Knight, Oklahoma City, OK (US)

(72) Inventor: Stephen Knight, Oklahoma City, OK (US)

(21) Appl. No.: 15/932,570

(22) Filed: Mar. 15, 2018

Related U.S. Application Data
(60) Provisional application No. 62/601,498, filed on Mar. 23, 2017.

(51) Int. Cl. A62C 3/00; A62C 31/12; A62C 37/36; A62C 33/04; A62C 5/02

(52) U.S. Cl. CPC A62C 3/00; A62C 31/12; A62C 5/02; A62C 33/04; A62C 37/04

(57) ABSTRACT

A portable integrated fire suppression system and first aid station for remote locations providing a water supply, a foaming agent, a mixer, a fluid pump and a selection of hoses or fixed integration into a stationary zonal suppression system with a remote activation control, the system delivered, monitored and possibly installed at a remote location for the suppression of fires and first aid treatment at remote locations, especially those having a high potential for industrial or commercial fire hazard activities and where local firefighting agencies are not immediately available.

### CROSS REFERENCE TO RELATED APPLICATIONS

Applicant claims the benefit of Provisional Patent App. No. 62/601,498, filed by the same inventor on Mar. 23, 2017.

### BACKGROUND OF THE INVENTION

### 1. Field of Invention

A portable integrated fire suppression system and first aid station for remote locations providing a water supply, a foaming agent, a mixer, a fluid pump and a selection of hoses or fixed integration into a stationary zonal suppression system with a remote activation control, the system delivered, monitored and possibly installed at a remote location for the suppression of fires and first aid treatment at remote locations, especially those having a high potential for industrial or commercial fire hazard activities and where local firefighting agencies are not immediately available.

### 2. Description of Prior Art

A preliminary review of prior art patents was conducted by the applicant which reveal prior art patents in a similar field or having similar use. However, the prior art inventions do not disclose the same or similar elements as the present portable remote fire suppression systems, nor do they present the material components in a manner contemplated or anticipated in the prior art.

In U.S. Pat. No. 9,067,090 to Henry, a hand-held portable foaming apparatus is disclosed which has a container holding a foaming agent, water and a pressurized gas, the foam generating apparatus having a snorkel a gas re-directional opening and a nozzle which is directed by hand. A portable cart having one or more chemical foam proportioners, one or more manifolds, one or more first valves, one or more check valves, one or more second manifolds and one or more fire suppression agent reservoirs is demonstrated in a method patent, U.S. Pat. No. 8,622,145 to Guse. A mobile nitrogen gas generator is shown in U.S. Pat. No. 7,588,612 to Marwitz to generate nitrogen gas from a wheeled vehicle.

In U.S. Pat. No. 6,761,266 to Carrier, a portable fire fighting apparatus provides a container having casters upon which is presented a water tank, a foaming agent tank, a gasoline powered engine operating a pump, and several hoses for directing the water/foam mixture at a fire with a valve system directing the water/foam mixture through two different hoses towards a fire. A fire suppression apparatus activated by a temperature sensor activates a tank containing a suitable fire extinguishing agent for discharge through the temperature activated sensor towards a pre-determined location, shutting off when the temperature condition no longer exists as disclosed in U.S. Pat. No. 6,029,751 to Ford. FIG. 1 represents the prior art summary of those suppression systems disclosed basically in Ford '751 and also as related to the Henry '090 patents both having local or remote activation devices which either embody a sensory system or a local activation means.

### SUMMARY OF THE INVENTION

Oil field operations, construction and demolition operations and other high fire risk occupations are often conducted in locations that do not have ready access to local fire departments in the even of a fire occurrence. Several prior art patents have attempted to address this risk by providing fire suppression devices for these remote hazards. They do not provide the same or similar apparatus for the suppression of fire as the present portable remote fire suppression system, having the capacity for the suppression of these industrial fires by the use of a manual and an integrated fixed zonal fire suppression with remote activation.

The present system contains a large volume water source, pump, foam induction system and additional water hookups for the fixed zonal system. It is provided as a stationary or mobile unit. It is rechargeable and intended for perpetual use. It may also be used in conjunction with a portable medical station manned by trained professional monitors. It also provides a variable output of the foaming fire suppression fluids which can be adjusted to the extinction of the fire dependent upon size, composition and volume. It also is provided with multiple lines and operational features for use by both portable manual operation of fixed location fire control.

### DESCRIPTION OF THE DRAWINGS

The following drawings are submitted with this utility patent application.

FIG. 1 is a drawing of prior art technologies similar to those seen in the disclosed prior art referenced above.

FIG. 2 is a drawing of a first unmanned portable fire suppression system providing an onboard self-contained power supply using at least one fire hose.

FIG. 3 is a drawing of a second unmanned portable fire suppression system providing connection to a local power plant and using at least one fire hose and a fixed location multiple zone suppression system.

FIG. 4 is a drawing of a first responder monitored portable fire suppression system providing an onboard self-contained power supply, at least one fire hose, a fixed location multiple zone suppression system, a monitoring station and a first aid station.

FIG. 5 is a drawing of a second first responder monitored portable fire suppression system providing an onboard self-contained power supply, at least one fire hose, a monitoring station and a first aid station.

### DESCRIPTION OF THE PREFERRED EMBODIMENT

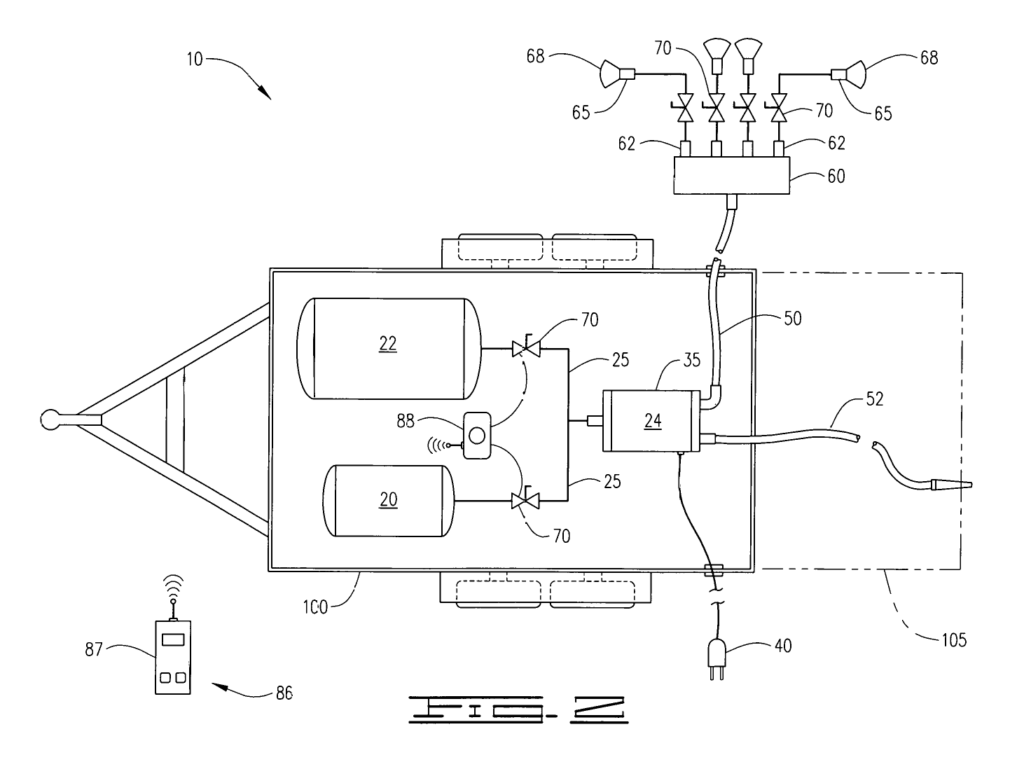

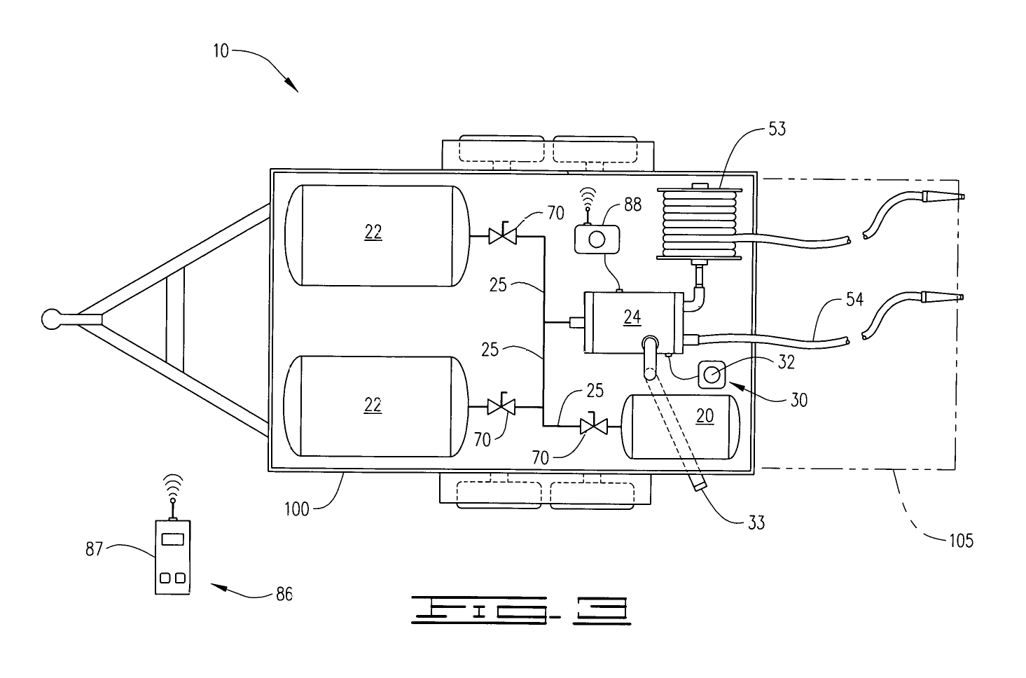

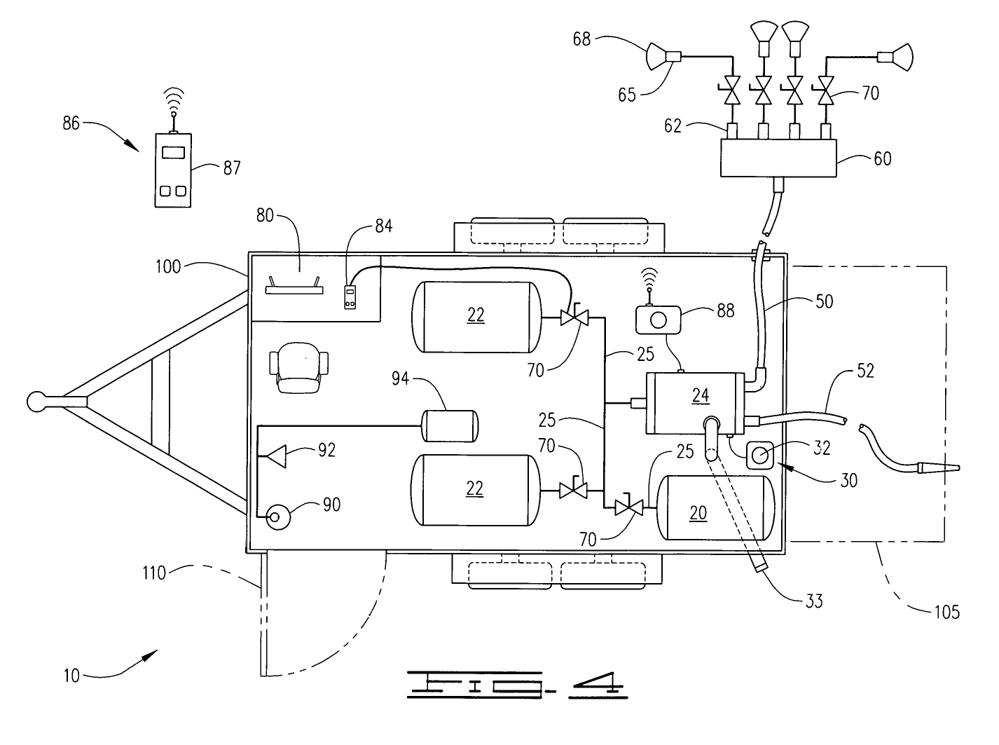

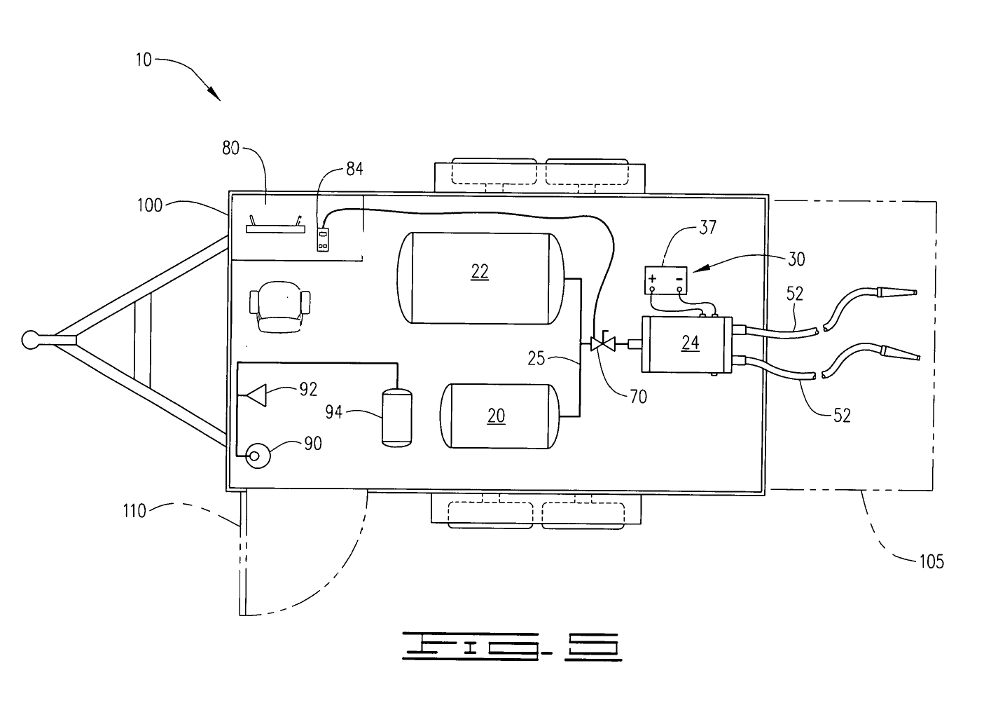

A portable fire suppression and first responder system 10 for remote locations provides a high volume output system for local fire suppression, most useful in industrial and commercial locations where fire hazard risk is high and local first responders are not within close proximity. The system is monitored on site by either a professional first responder trained in fire suppression and first aid or local personnel cross-trained in fire suppression and first aid. This system is ideally suited for oil field operations, construction and destruction activities, hazardous chemical operations, refineries, process plants and combustible manufacturing processing. The system provides an integrated water supply, foaming agent, mixer, pump and at least one manual hose for direction of the foam and water mixture towards a fire and/or connection to a fixed suppression system set in place toward one or more zones where the fire threat risk is most present. Each zone involved would include a valve within a manifold to select the zone requiring suppression, with a supplemental manual hose. FIG. 2 represents a diagram of a manual and fixed suppression system and FIG. 3 represents a manual only system in two embodiments. FIG. 4 represents a manual and fixed suppression system, first aid station and local monitoring area while FIG. 5 represents a manual system with a first aid station and local monitoring area in two embodiments. FIGS. 2-5 represent the basic set up for the portable system and its essential components contained within a portable trailer which is directed and available for transport to various locations as chosen by the site management user.

Each system 10, shown in the four embodiments required the same essential components, including a foaming agent vessel 20, a water vessel 22, a mixer and pump 24, fluid lines 25 connecting the water vessel 22 and foaming agent vessel 20 to the mixer and pump 24, either a local power source 30 or a connection to a nearby power supply 40, suppression lines 50 directed from the mixer and pump 24 to either one or more manual fire suppression hoses 52 or a fixed fire suppression manifold 60 further connecting to one or more fixed zone emitters 65 directed to a plurality of pre-determined hazard zones, and a series of valves 70 located within each fluid line 25 and suppression line 50 which open and close to allow fluid passage to the various fluid and suppression lines 25, 50, mixer and pump 24 and fixed fire suppression manifolds 60 which are activated and selectively controlled by the first responder monitor, all included within a portable transport trailer 100 or vehicle. An activation means 84, 85, is included to activate the mixer and pump 24, control the valves 70 and to direct the water and foaming agent mixture to the one or more manual lines 52 and hoses 53, 54, and/or the fixed zone emitters 65, as well as to control the fire suppression fixed manifold 60 distribution. In those embodiments which include the first aid and local monitoring by a first responder, there is an additional eyewash station 90, a chemical shower 92 station, an independent sanitary water tank 94 supplying pressure to direct the sanitary water to the eyewash station 90 and chemical shower 92 and a monitoring station 80 allowing the first responder to provide local monitoring of the site being monitored as well as room to treat those who may have sustained injury until emergency medical personnel can arrive on location.

Most preferably, the components are described and indicated, with minimal criteria for each component as follows. The mixer and pump 24 is at least an 18 HP gasoline fluid pump 32 having a capacity to compel 200 gallons of fluid per minute, FIGS. 3-4. The gasoline fluid pump 32 requires an external exhaust line 33 which directs combustion gasses outside the trailer 100, FIGS. 3-4. The mixer and pump 24 may also be an electrical pump 35 where electrical service is established and available, FIG. 2, or supplied by a battery 37, FIG. 5.

The water vessel 22 is provided and represented by at least two 275 gallon container which are refillable, FIGS. 2-5. The foaming agent vessel 20 contains nothing less than Class A foam concentrate or its equivalent and would be suited for the water vessel capacity in a 12 gallon vessel of Class A foam, FIGS. 2-5. As shown, first fluid lines 25 connect each water vessel 22 and foaming agent vessel 20 to the mixer and pump 24, which is adjusted to an appropriate level to combine the Class A foam concentrate with water which would eliminate the water and the Class A foam concentrate at a rate which would drain each vessel in cooperation, the mixer integrated within the pump. It is contemplated that the fluid line 25 from the foaming agent vessel 20 and water vessel 22 may include the valves 70 which would allow the operator to send water only to the mixer and pump 24.

Suppression lines 50 direct the suppression mixture of foam and water to at least one manual line 52 or hose 53, 54, FIGS. 2-5. It is recommended that a first hose and reel 53, FIG. 3, would be no less than a one inch rubber line with a nozzle which would provide a variable suppression flow rate of 5-40 gallons per minute, while a second folding flat hose 54, FIGS. 2-5 is provided at a flat lie 1½ inch hose allowing a variable suppression flow rate of between 10-125 gallons per minute. On the fixed fire suppression manifold 60 embodiments, FIGS. 2 and 4, the suppression line 50 extends through the trailer 100 from the mixer and pump 24 to the fixed fire suppression manifold 60 which directs the suppression water and foam mixture to one or more selected manifold lines 62 to respective fixed zone emitters 65 which have been directed to one or more potential hazard zones in the monitored areas by local operators within the area. The manual hoses 52-54, are preferably stored and deployed from the inside of the trailer 100.

FIGS. 2-5 further indicate the trailer 100 to have a rear door 105 which allows rear access to the trailer 100 for replenishment of water and foaming agent and fuel for the pump, where indicated by phantom lines showing the rear door 105 in an open position in FIGS. 2-5. In addition, a separate trailer side door 110 is located in the first responder and monitoring station 80 for access by the first responder and also access to the first aid stations as shown in FIGS. 4-5 by any injury victim for treatment. For purposes of the disclosed embodiments, the trailer 100 is indicated in FIGS. 2-5. However, it is contemplated that the trailer may be self-propelled within a mobile transport unit, incorporating the same components within a box truck or vehicle similar to a recreational vehicle, not shown. Transportation of the system may also be provided by a four wheel utility vehicle, a flatbed truck, on a skid loaded and unleaded by a skid loader, set into position by airlift, or supplied on open trailers. The mobility aspect of the trailer 100 or other indicated methods of transport allow for the placement and set up of the entire system at a well site or any location where the system would be useful. The system 10 is ready and operational the moment the system arrives at the delivery site.

The provision to a fixed fire suppression manifold embodiment allows for a single suppression line 50 connection to the fixed suppression manifold 60, subject to installation by the set-up operator of the system, providing a momentary integration into the site location, either pre-determined by the operator or the site manager, of for thoughtful and meaningful location of the one or more zone emitters 65 and/or valves 70 based upon an evaluation of the fire hazard risk associated with the operational zones, the number of zone emitters 65 required, and a synchronisation of the zone emitters 65 based on situational analysis by the operator, most preferred one with vast knowledge, expertise and training in the filed of fire suppression. Each zone emitter 65 further defines a nozzle 68 directed to the pre-determined hazard zone with, with each nozzle 68 independently capable of adjustment of water flow, spread pattern and targeting, with each nozzle 68 attaching to a component within the pre-determined hazard zone by an anchoring means, not shown, which retains each nozzle 68 without movement once set. Ideally suited would be off duty or retired trained career firefighters as first responders and local monitors. This system 10 is not suggested for use by novices or those who have no training in the filed of tire suppression, which would likely render the system less than optimally useful.

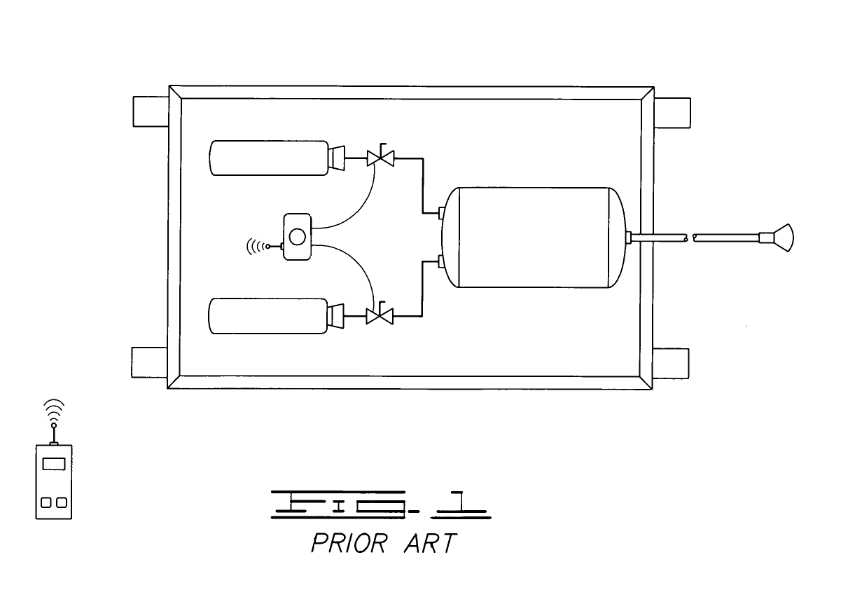

It is also contemplated that the system 10 may be started by a remote activation means 86 and a local activation means 84, FIGS. 1-4, pre-directed to a pre-determined zone, with the local and remote activation means 84, 86, capable of zone selection, the remote activation means 86 operating the mixer and pump 24 and controlling and selecting the valves 70 controlling each zone emitter 65. In this instance, a first responder and local monitor or one or more designated employee can keep this remote activation means 86 on their respective person by use of a lanyard, belt clip or at a designated and visible set location at the operational site, used in the same nature as a “panic button”. Once a fire is recognized, the instantaneous activation of the local or remote activation means, 84, 86, can be executed, with the fire suppression activated within the reaction time of the operator or local employee. The remote activation means 86, as indicated in FIGS. 2-5 involves a transmitter 87 and a receiver 88, which may operate on any wireless communication system and wavelength, including infrared, microwave, bluetooth or other wireless communication means, ideally placed in a communication mode which allows for communication between the transmitter and receiver which is unique and not subject to other wireless communication in the monitored area.

It is the purpose of the present system 10 to provide a high volume local fire suppression capability to a location where local government sponsored fire suppression departments are not readily available. However, even where local firefighters are available, the provision of the system 10 for instantaneous suppression of a fire is beneficial, especially in construction or operation areas or buildings where the fire suppression system has yet to be installed, since even local emergency responders can be delay during travel to the location. The ability for instantaneous response can save precious lives and property damage caused even in the first minute or two during a crisis emergency. As worker safety becomes more and more important, it is likely that local fire suppression may be mandate by local, state and federal regulations. The present system 10, unlike other fire suppression systems, resolves a need directed to worker safety not heretofore present in the prior art.

Contemplated uses may also include residential homes under construction or any location where combustible fuels are present, including fuel fluids, electricity, paint, lumber, paper, drywall, or any source of direct heat. It is also useful at any location which provides welding or other open flame manufacturing process where people are present. This present system 10 can save the life of a person at or near the location of a fire eruption or other personal injury for any person present at a scene by the quick application of the present fire suppression and first aid system 10. It can also avoid, reduce or minimize property damage. The embodiments shown in FIGS. 2-5 may include variations and combinations of many different embodiment by combining different elements of each drawing figure, and are not intended to limit the combinations of essential and alternative combinations as disclosed herein, with all possible variations contemplated within the scope of the portable integrated fire suppression and first aid systems. It will be understood by those skilled in the art that changes in form and detail may be made therein without departing from the spirit and scope of the invention.

What is claimed is:

1. A portable fire suppression and first responder system for remote locations providing a high volume output system for local fire suppression, most useful in industrial and commercial locations where fire hazard risk is high and local first responders are not within close proximity, said system comprising:
a trailer or other portable transport platform, said trailer defining a rear door, said trailer further containing;
a refillable foaming agent vessel containing a quantity of a Class A foam concentrate or its substantial equivalent of no less than 12 gallons capacity;
one or more refillable water vessel providing a capacity of water of no less than 500 gallons;
a fluid line connecting said water vessel to a mixer and pump and a fluid line connecting said foaming agent vessel to said mixer and pump, delivering said foaming agent and water to said mixer and pump, each said fluid line containing a valve;
a local power source operating said mixer and pump to forcibly compel said water and foaming agent mixture from said mixer and pump into at least one suppression line, said at least one suppression line further attaching at least one manual line, at least one fixed manifold, or both, each said suppression line containing a valve;
said at least one fixed manifold further extending one or more manifold lines attaching to a zone emitter terminating in a nozzle further directed to a pre-determined location within said industrial or commercial location at one or more said hazard risks, each said manifold line containing a valve; and
a local activation means to activate said pump and provide for a selection of said valves to direct and control the flow of said foaming agent and water mixture or water only to said at least one manual line, said one fixed manifold and further to at least one said zone emitter, or a combination of said manual line and said one fixed manifold as determined by the operator and monitor of said system.

2. The portable fire suppression and first responder system of claim 1, further comprising:
said local power source provided by a gasoline engine with an exhaust line directing combustion gasses outside the trailer.

3. The portable fire suppression and first responder system of claim 1, further comprising:
said local power source provided by an electrical motor attaching to an external electrical power supply.

4. The portable fire suppression and first responder system of claim 1, further comprising:
said local power source provided by a battery.

5. The portable fire suppression and first responder system of claim 1, further comprising:
a remote activation means to additionally activate said pump and provide for a selection of said valves to direct and control the flow of said foaming agent and water mixture or water only to said at least one manual line, said one fixed manifold and further to at least one said zone emitter, or a combination of said manual line and said one fixed manifold as determined by the operator and monitor of said system, said remote activation means comprising a remote transmitter and receiver integrated within said local power source for which communication between said transmitter and said receiver is any wireless communication system and wavelength, including infrared, microwave, bluetooth or other wireless communication means, ideally placed in a communication mode which allows for communication between the transmitter and receiver which is unique and not subject to other wireless communication in the monitored area.

6. The portable fire suppression and first responder system of claim 1, further comprising:
each said manual line is a reel hose of no less than one inch rubber with a nozzle which would provide a variable suppression flow rate of 5-40 gallons per minute; or
a folding flat lie hose of at least 1½ inch diameter with a nozzle which would provide a variable suppression flow rate of 10-125 gallons per minute; or
both said reel hose and said folding flat lie hose.

7. The portable fire suppression and first responder system of claim 1, further comprising:
a local monitoring station at which said local activation means is located, said local monitoring station further defining an eyewash station, a chemical shower station, an independent sanitary water tank supplying pressure to direct the sanitary water to the eyewash station and chemical shower, said monitoring station monitored by a trained first responder to provide local monitoring of said industrial and commercial and provide treatment to those who may have sustained injury until emergency medical personnel can arrive on location.

8. A portable fire suppression and first aid station system, monitored by a trained first responder at remote locations providing a high volume output system for local fire suppression and emergency medical first aid, most useful in industrial and commercial locations where fire hazard risk is high and local first responders are not within close proximity, said system comprising:
a trailer or other portable transport platform, said trailer defining a rear door, said trailer further containing;
a refillable foaming agent vessel containing a quantity of a Class A foam concentrate or its substantial equivalent of no less than 12 gallons capacity;
one or more refillable water vessel providing a capacity of water of no less than 500 gallons;
a fluid line connecting said water vessel to a mixer and pump and a fluid line connecting said foaming agent vessel to said mixer and pump, delivering said foaming agent and water to said mixer and pump, each said fluid line containing a valve;
a local power source operating said mixer and pump to forcibly compel said water and foaming agent mixture from said mixer and pump into at least one suppression line, said at least one suppression line further attaching at least one manual line, at least one fixed manifold, or both, each said suppression line containing a valve;
said at least one fixed manifold further extending one or more manifold lines attaching to a zone emitter terminating in a nozzle further directed to a pre-determined location within said industrial or commercial location at one or more said hazard risks, each said manifold line containing a valve;
a local activation means to activate said pump and provide for a selection of said valves to direct and control the flow of said foaming agent and water mixture or water only to said at least one manual line, said one fixed manifold and further to at least one said zone emitter, or a combination of said manual line and said one fixed manifold as determined by the operator and monitor of said system; and
a local monitoring station at which said local activation means is located, said local monitoring station further defining an eyewash station, a chemical shower station, an independent sanitary water tank supplying pressure to direct the sanitary water to the eyewash station and chemical shower, said monitoring station monitored by said trained first responder to provide local monitoring of said industrial and commercial and provide treatment to those who may have sustained injury until emergency medical personnel can arrive on location.

9. The portable fire suppression and first responder system of claim 8, further comprising:
said local power source provided by a gasoline engine with an exhaust line directing combustion gasses outside the trailer.

10. The portable fire suppression and first responder system of claim 8, further comprising:
said local power source provided by an electrical motor attaching to an external electrical power supply.

11. The portable fire suppression and first responder system of claim 8, further comprising:
said local power source provided by a battery.

12. The portable fire suppression and first responder system of claim 8, further comprising:
a remote activation means to additionally activate said pump and provide for a selection of said valves to direct and control the flow of said foaming agent and water mixture or water only to said at least one manual line, said one fixed manifold and further to at least one said zone emitter, or a combination of said manual line and said one fixed manifold as determined by the operator and monitor of said system, said remote activation means comprising a remote transmitter and receiver integrated within said local power source for which communication between said transmitter and said receiver is any wireless communication system and wavelength, including infrared, microwave, bluetooth or other wireless communication means, ideally placed in a communication mode which allows for communication between the transmitter and receiver which is unique and not subject to other wireless communication in the monitored area.

13. The portable fire suppression and first responder system of claim 8, further comprising:
each said manual line is a reel hose of no less than one inch rubber with a nozzle which would provide a variable suppression flow rate of 5-40 gallons per minute; or
a folding flat lie hose of at least 1½ inch diameter with a nozzle which would provide a variable suppression flow rate of 10-125 gallons per minute; or
both said reel hose and said folding flat lie hose.

14. The portable fire suppression and first responder system of claim 8, further comprising:
any other element disclosed within the specification and drawings contained herein.
